(19) United States
(12) Patent Application Publication
(10) Pub. No.: US 2026/0135815 A1
(43) Pub. Date: May 14, 2026

(54) CROSS LAYER OPTIMIZATION FOR ENABLING LOW LATENCY, LOW LOSS, SCALABLE THROUGHPUT

(71) Applicant: Cisco Technology, Inc., San Jose, CA (US)

(72) Inventors: Peiman Amini, Fremont, CA (US); Ardalan Alizadeh, Milpitas, CA (US); Juan Carlos Zuniga, Montreal (CA); Bahador Amiri, Saratoga, CA (US)

(73) Assignee: Cisco Technology, Inc., San Jose, CA (US)

(21) Appl. No.: 19/278,254

(22) Filed: Jul. 23, 2025

Related U.S. Application Data
(60) Provisional application No. 63/718,797, filed on Nov. 11, 2024.

(51) Int. Cl. H04L 47/32; H04L 47/11; H04L 47/36; H04L 47/38; H04L 47/52; H04L 47/80

(52) U.S. Cl. CPC H04L 47/32; H04L 47/36; H04L 47/38; H04L 47/52; H04L 47/11; H04L 47/805

(57) ABSTRACT

Managing Low Latency, Low Loss, Scalable Throughput (L4S) traffic may be provided. Managing L4S traffic can include receiving network data comprising one or more Physical (PHY) layer metrics, one or more Media Access Control (MAC) layer metrics, and one or more network layer metrics. Network conditions are determined based on the network data. One or more L4S characteristics are then set based on the network conditions.

### RELATED APPLICATION

This application claims priority to U.S. Provisional Patent Application No. 63/718,797, titled “Cross-Layer Optimization for Enabling L4S in WiFi Networks,” filed Nov. 11, 2024, the disclosure of which is hereby incorporated by reference in its entirety.

### TECHNICAL FIELD

The present disclosure relates generally to managing Low Latency, Low Loss, Scalable Throughput (L4S) traffic.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for managing Low Latency, Low Loss, Scalable Throughput (L4S) traffic in accordance with aspects of the present disclosure.

FIG. 2 is a block diagram of cross-layer data collection in accordance with aspects of the present disclosure.

FIG. 3 is a block diagram of an L4S queuing system in accordance with aspects of the present disclosure.

FIG. 4 is a flow chart of a method for managing L4S traffic in accordance with aspects of the present disclosure.

FIG. 5 is a block diagram of a computing device in accordance with aspects of the present disclosure.

FIG. 6 is a block diagram of a computing device in accordance with aspects of the present disclosure.

### DETAILED DESCRIPTION

### Overview

Managing Low Latency, Low Loss, Scalable Throughput (L4S) traffic may be provided. Managing L4S traffic can include receiving network data comprising one or more Physical (PHY) layer metrics, one or more Media Access Control (MAC) layer metrics, and one or more network layer metrics. Network conditions are determined based on the network data. One or more L4S characteristics are then set based on the network conditions.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Open System Interconnection model of networking includes seven abstraction layers for communications between systems. Layer 2 is the data link layer, and layer 3 is the network layer. The data link layer comprises the Logical Link Control (LLC) sublayer and the Medium Access Control (MAC) sublayer and is responsible for transferring data between nodes on a network segment across the Physical (PHY) layer. The network layer is responsible for transferring packets from a source to a destination via one or more networks.

Low Latency, Low Loss, Scalable Throughout (L4S) is an architecture and protocol described in the Internet Engineering Task Force (IETF) standards (e.g., the IETF Request for Comment (RFC) 9330, 9331, 9332). L4S is implemented to provide low queuing latency, low congestion loss, and scalable throughput control for streaming video, multiplayer games, and other real-time applications. By handling data packet processing and reducing network congestion, L4S minimizes delays caused by queue bloat and enables smoother and more efficient data transmission.

L4S is intended to enable low latency and low loss communications. However, network performance utilizing L4S can be affected by fluctuating signal conditions (e.g., deep fading), interference (e.g., by Overlapping Basic Service Sets (OBSS) and non-Wi-Fi devices), and contention for the medium due to high density or utilization. Traditional network management strategies operate within siloed network layers and do not utilize inter-layer optimization. This conventional approach is particularly inadequate when it comes to enabling L4S services which demand an integrated perspective of the network's state across different layers to meet their low latency and loss requirements.

Systems and processes are described herein for leveraging cross-layer optimization to bridge the divide between PHY and MAC layers and the network layer's congestion control and Active Queue Management (AQM) mechanisms. Cross-layer optimization enhances L4S traffic management across Access Points (APs) by enabling optimizing of network operations across multiple layers. Through a combination of adaptive management, predictive modeling, and integrated cross-layer feedback, network parameters can be adjusted in real-time to ensure optimal performance of L4S traffic (e.g., as characterized by low latency and minimal loss) even with fluctuating network conditions. Network conditions can include congestion, queuing delay, packet loss rate, L4S marking rate, round-trip time variations, traffic load, link utilization, the mix of flow between L4S and classic traffic, queue occupancy or buffer size, latency, jitter, scheduler backlogs, deviation from fairness targets, network topology or path changes, traffic types, and so on.

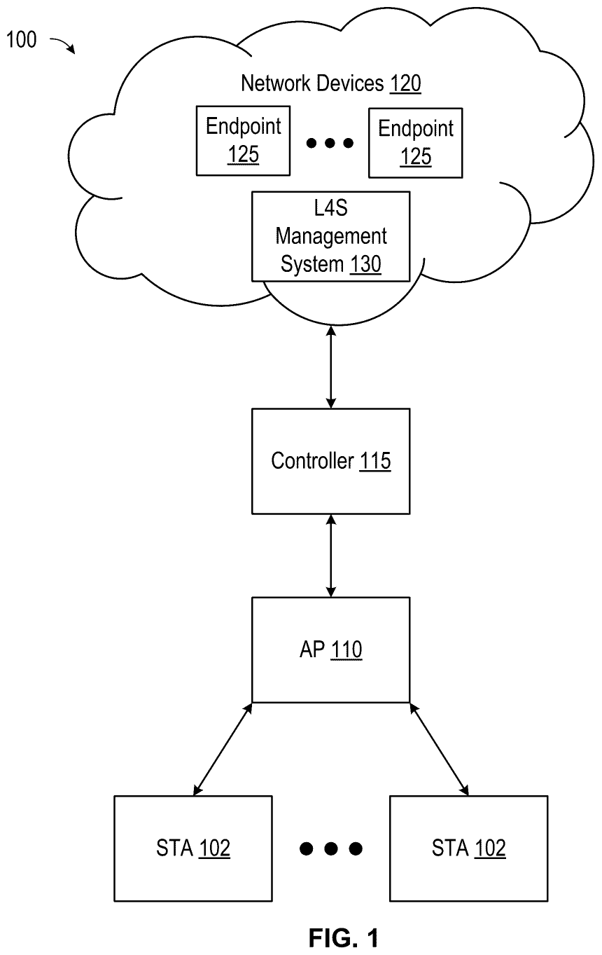

FIG. 1 is a block diagram of an operating environment 100 for managing L4S traffic. The operating environment 100 includes Stations (STAs) 102, an AP 110, a controller 115, and network devices 120 in the illustrated embodiment.

The STAs 102 are any device that can wirelessly communicate with the AP 110, such as a personal computer, a smart phone, a server, a video game console, a tablet, a virtual reality device, and the like. The AP 110 is configured to communicate with and/or enable devices such as the STAs 102 to enable communication with the network devices 120. The controller 104 is a network controller, such as a Wireless Local Area Network (WLAN) controller, configured to manage and control the AP 110, the STAs 102, and/or other network devices to allow wireless devices to communicate with the network devices 120. The STAs 102, the AP 110, and the controller 115 can form a WLAN. The AP 110 and/or the controller 115 can include router components or connect to an external router for routing traffic and otherwise managing the operation of the WLAN. In certain embodiments, the AP 110 acts as a controller and the controller 115 is not present in the operating environment 100. For example, the AP 110 can include components to act as a WLAN controller.

The network devices 120 are a set of devices that facilitate communication between senders and destinations, such as by implementing communication protocols. Example network devices 120 can form local area networks, wide area networks, intranets, or the Internet. The network devices 120 can include endpoints 125. The endpoints 125 can serve as an endpoint for data communications, such as from an STA 102. In certain embodiments, the network devices 120 include a L4S management system 130 for dynamically managing L4S traffic. In some embodiments, one or more components of the L4S management system 130 can be part of and/or processes described as performed by the L4S management system 130 can be performed by another device of the operating environment 100 (e.g., STAs 102, the AP 110, and/or the controller 115). The L4S management system 130 can be part of routers, switches, and/or APs like the AP 110 for example.

The operating environment 100 is a computer network with one or more WLANs and/or other networks in example embodiments. A computer network is a geographically distributed collection of nodes interconnected by communication links and segments for transporting data between end nodes (e.g., an STA 102 and an end node of the network devices 120). Many types of networks can be part of the operating environment, from local area networks (LANs) to wide area networks (WANs). LANs typically connect the nodes over dedicated private communications links located in the same general physical location, such as a building or campus while WANs typically connect geographically dispersed nodes over long-distance communications links, such as common carrier telephone lines, optical networks, or the like. The Internet is an example WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

In certain embodiments, the devices of the operating environment 100 can use artificial intelligence (e.g., machine learning) techniques, such as to manage L4S traffic. The L4S management system 130 can use artificial intelligence techniques to perform cross-layer analysis of the network, predictively model future network conditions, manage L4S, and/or the like for example. In general, machine learning is concerned with the design and the development of techniques that take data (e.g., network statistics, performance indicators) as input, and recognize complex patterns in the data. One common pattern among machine learning techniques is the use of an underlying model L, whose parameters are optimized for minimizing the cost function associated to the model L, given the input data. For instance, in the context of classification, the model L may be a straight line that separates the data into two classes (e.g., labels) such that L=a*x+b*y+c and the cost function would be the number of misclassified points. The learning process then operates by adjusting the parameters a, b, c such that the number of misclassified points is minimal. After this optimization phase (or learning phase), the model L can be used to classify new data points. Often, the model L is a statistical model, and the cost function is inversely proportional to the likelihood of L, given the input data.

In various implementations, one or more devices of the operating environment 100 employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. Unsupervised techniques do not require a training set of labels. While a supervised learning model may look for previously seen patterns that have been labeled as such, an unsupervised model may instead look to whether there are sudden changes or patterns in the behavior of the attributes. Semi-supervised learning models are a mixed approach that use a reduced set of labeled training data.

Example machine learning techniques that the one or more devices of the operating environment 100 can employ include Nearest Neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), Support Vector Machines (SVMs), Generative Adversarial Networks (GANs), Long Short-Term Memory (LSTM), logistic or other regression, Markov models or chains, Principal Component Analysis (PCA) (e.g., for linear models), Singular Value Decomposition (SVD), Multi-Layer Perceptron (MLP) Artificial Neural Networks (ANNs) (e.g., for non-linear models), replicating reservoir networks (e.g., for non-linear models, typically for timeseries), random forest classification, and/or the like.

In further implementations, the devices of the operating environment 100 are capable of using one or more generative artificial intelligence models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, Generative Adversarial Networks (GANs), Large Language Models (LLMs), other transformer models, and/or the like.

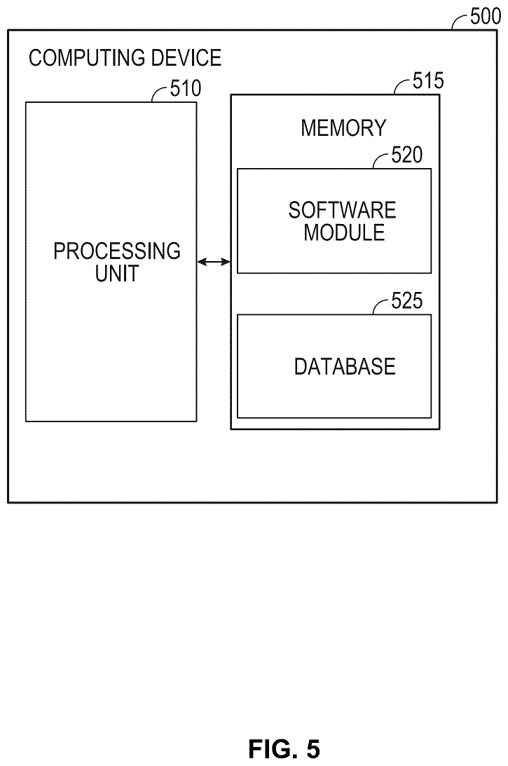

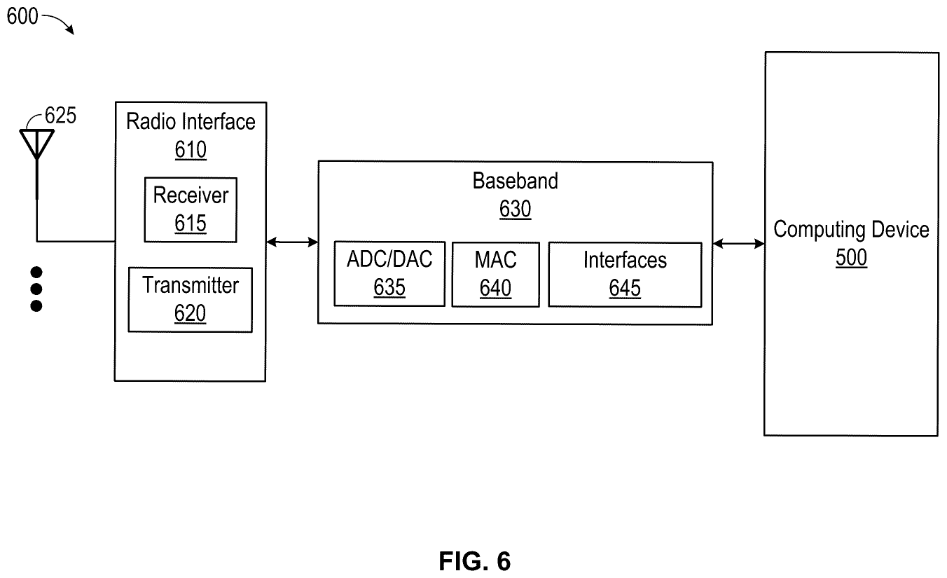

The elements described above of the operating environment 100 (e.g., the STAs 102, the AP 110, the controller 115, the endpoints 125, the L4S management system, other network devices 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

### L4S Management

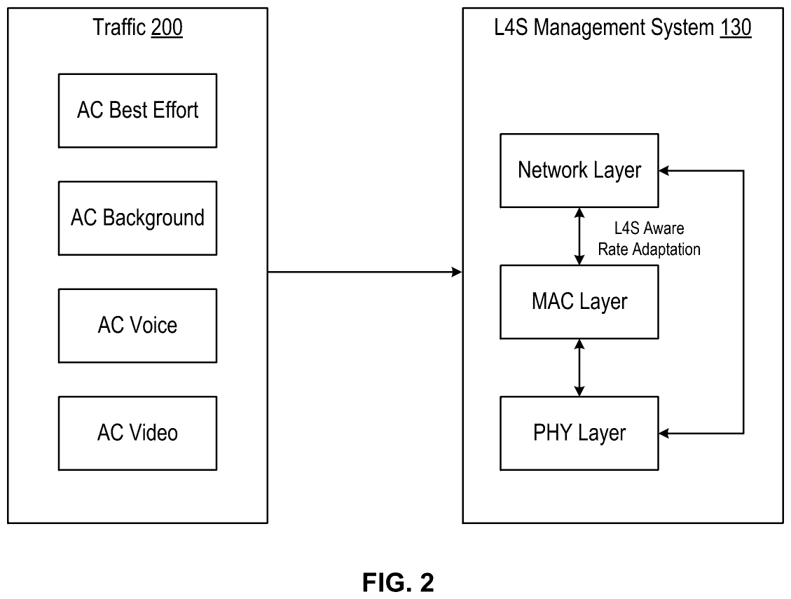

FIG. 2 is a block diagram of cross-layer data collection. The L4S management system 130 can dynamically adjust L4S traffic handling by leveraging real-time feedback from the PHY layer, MAC layer, and the network layer, such as Explicit Congestion Notification (ECN) signals from the network layer. For example, the L4S management system 130 can receive network information for traffic 200 across the PHY layer, the MAC layer, and the network layer.

Based on the cross-layer network data, the L4S management system 130 can adjust L4S characteristics such as queue management settings and ECN marking thresholds to improve L4S traffic handling (e.g., to ensure low latency and minimal loss even under fluctuating network conditions). The L4S management system 130 is configured to adjust or otherwise manage queue sizes, thresholds for ECN marking, ECN marking strategies, drop policies (e.g., when to drop packets and which packets to drop), which queue management algorithm is used, target delay, interval or update periods, and/or L4S balancing strategies (e.g., defining bandwidth sharing and fairness) in example implementations.

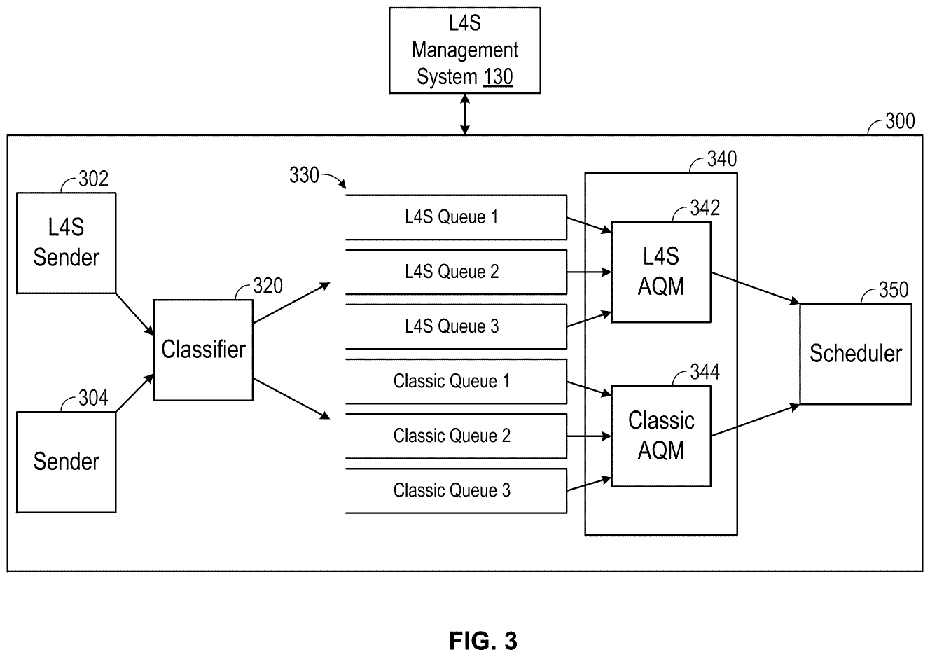

FIG. 3 is a block diagram of an L4S queuing system 300. The L4S queuing system 300 can include a L4S sender 302, a sender 304, a classifier 320, queuing mechanism 330, an AQM 340 including a L4S AQM component 342 and a classic AQM component 344, and a scheduler 350. The L4S queuing system 300 can be utilized in one or more positions of the operating environment 100, such as at the AP 110, at other APs, at routers, at the controller 115, at a gateway, at a switch, at a cloud controller, and/or the like.

The L4S sender 302 can be a traffic source, such as an L4S capable STA 102 or a device of the network devices 120, sending L4S traffic. The sender 304 can be a traffic source, such as a legacy STA 104 or a device of the network devices 120, sending non-L4S traffic. The classifier 320 can classify the types of traffic and sort L4S traffic and non-L4S traffic into different queues of the queuing mechanism 330. For example, the classifier 320 sorts the traffic of the L4S sender 302 to an L4S queue and the traffic of the sender 304 to a classic queue. The illustrated queuing mechanism 330 includes three L4S queues and three classic queues, but the queuing mechanism 330 can comprise any number of queues.

The AQM 340 can mark (e.g., ECN marking) and drop packets based on congestion. For example, the L4S AQM component 342 can mark packets from the L4S queues to signal impending congestion before packets are dropped. The classic AQM component 344 can drop packets from the classic queues when congestion is experienced. The scheduler 350 manages the order and timing of packet transmissions from the queues, for example according to priority, fairness, coordination with AQM components, and/or the like. The L4S management system 130 can manage the operation of the L4S queuing system 300, such as managing operation of the classifier 320 organizing traffic in the queues of the queuing mechanism 330, setting the size of the queues in the queuing mechanism 330, managing operation of the AQM 340 (e.g., by adjusting thresholds for marking), managing operation of the scheduler 350, setting performance targets for latency and loss, and/or the like.

The L4S management system 130 can initially set default parameters for L4S traffic. The default parameters can include baseline thresholds for ECN marking based on typical network conditions and predefined performance targets for latency and loss. The AQM 340 can use the ECN marking thresholds to determine when to mark packets. In example implementations, the ECN marking thresholds include a minimum queue length where marking will not occur below that length, a maximum queue length where all packets will be dropped, and, between the minimum queue length and maximum queue length, probabilistic marking and dropping. The probabilistic queue marking and dropping can include randomly marking and/or dropping packets with a probability that increases as congestion increases. In further embodiments, the thresholds can be based on queue delay times instead of the length of the queues. The performance targets can cause systems to adjust L4S operation, such as the classifier 320 adjusting which packets are sent to which queue, the AQM 340 adjusting when packets are marked and when to respond to growing queues, increasingly favoring L4S traffic over classic traffic, and the like.

The L4S management system 130 can monitor the network and traffic to manage L4S operations. In some embodiments, the L4S management system 130 continuously monitors PHY and MAC layer metrics, including signal quality (e.g., Signal-to-Noise Ratio (SNR), Modulation and Coding Scheme (MCS)), frame retry rates, and airtime contention levels. The L4S management system 130 also evaluates ECN signals from the network layer in certain embodiments, analyzing the markings in conjunction with the collected PHY and MAC layer metrics to determine network conditions, such as the congestion. This L4S management system 130 can perform the analysis to determine whether the network conditions are degrading and if preemptive action is needed to adjust L4S management settings. Therefore, the L4S management system 130 uses the cross-layer information to determine the current state of the network and to identify signs of potential congestion.

Based on the cross-layer information, the L4S management system 130 can adjust L4S operation. In one embodiment, the L4S management system 130 adjusts the length of queues (e.g., queues in the queuing mechanism 330) based on the detected volume of L4S traffic and current network congestion levels. During peak hours or other periods of congestion, the L4S management system 130 may automatically shorten queue lengths to prioritize handling of L4S packets. Shortening the queue lengths increases the speed that L4S packets are sent to reduce latency for time-sensitive applications. The L4S management system 130 can also switch queue management algorithms based on congestion levels. For example, the L4S management system 130 may switch to a more aggressive queue management algorithm (e.g., Controlled Delay (CoDel) or Random Early Detection (RED)) when congestion or developing congestion is detected to minimize queuing delay and packet loss. The selection of the algorithm may be contingent upon the specific network conditions identified.

The L4S management system 130 can also analyze traffic patterns and types of applications generating L4S traffic to adjust queue management strategies. For instance, the L4S management system 130 may recognizing a surge in traffic associated with a specific type of traffic requiring low latency and loss (e.g., video conferencing) and can trigger adjustments to prioritize the traffic.

The L4S management system 130 can additionally adjust ECN marking thresholds based on the cross-layer information. For example, in scenarios where signal quality is poor, the L4S management system 130 can lower the threshold for ECN marking to signal congestion earlier, prompting upstream nodes to reduce their sending rates accordingly.

As the L4S management system 130 makes adjustments to L4S operation, the L4S management system 130 can evaluate the impact of the adjustments to determine the impact of the adjustments and make further adjustments. For example, the L4S management system 130 uses a feedback loop to evaluate the outcomes of the adjustments on L4S traffic performance. Based on the evaluation, the L4S management system 130 further refines the L4S parameters to optimize for low latency and loss.

The L4S management system 130 also makes adjustments as network conditions change, continuously monitoring network and traffic, analyzing information, and optimizing L4S characteristics to increase L4S traffic performance under varying network states. The L4S management system 130 system may focus on user-centric performance metrics, such as application response times and video streaming quality, to determine L4S characteristics in example implementations. By aligning the adjustments with the end-user experience, the L4S management system 130 can operate to generate tangible benefits for users, such as smoother streaming and more responsive online gaming. In another embodiment, the L4S management system 130 can integrate signals and metrics from application and transport layers with PHY and MAC layer feedback for more nuanced decision-making, such as using application layer insights (e.g., video streaming buffer health) to influence how L4S traffic is managed at lower layers.

Thus, the L4S management system 130 monitors network and traffic conditions across layers and ECN marking data to dynamically adjust L4S characteristics for managing L4S traffic. Adjusting the L4S characteristics can include setting queue sizes, setting thresholds for ECN marking, setting ECN marking strategies, setting drop policies, determining which queue management algorithm to use, setting target delay, setting interval or update periods, setting bandwidth sharing and fairness, and/or the like.

### Predictive Modeling

In certain embodiments, the L4S management system 130 predicts future network and traffic conditions to proactively manage L4S operation. The L4S management system 130 can utilize historical and real-time network data to predict network congestion and dynamically adjust L4S settings to meet desired performance characteristics. The network data can include historical and real-time data of PHY layer metrics (e.g., SNR, MCS), MAC layer metrics (retry rates, airtime contention levels), and network layer metrics (e.g., ECN marking).

The L4S management system 130 can utilize a predictive machine learning model to predict future network conditions, such as congestion, based on the historical and real-time network data. The machine learning model can use historical data and any other training data to compare current network conditions, including changes to the network conditions, to predict future network conditions. The L4S management system 130 then determines L4S characteristics for increasing L4S performance under the predicted future network conditions or to address the prediction (e.g., the future network conditions include high levels of marked and dropped packets, so L4S characteristics are changed to reduce the marking and dropping of packets).

Hence, the L4S management system 130 uses the model's predicted network conditions to make preemptive adjustments to L4S characteristics, such as AQM 340 configurations, queue lengths, and ECN marking thresholds. In some embodiments, the L4S management system 130 can implement the adjustments before actual congestion is detected by real-time metrics and in advance of predicted congestion periods, aiming to mitigate potential performance degradation before it occurs. The L4S management system 130 can utilize the model to adjust characteristics in response to immediate predictions of congestion and in response to longer-term forecasts for periods of expected high network utilization, such as during special events or peak usage hours.

In some embodiments, the L4S management system 130 uses gradient boosting techniques (e.g., the model is a gradient boosting technique). The L4S management system 130 may utilize gradient boosting techniques to balance performance and computational efficiency, suitable for both linear and non-linear relationships in network metrics.

The model may be trained on historical data so the model can identify patterns and correlations between various metrics and network congestion events. In example implementations, the model uses correlation analysis during training to identify features of the network data that more accurately indicate future network conditions, such as for higher predictive power for congestion. The model can then use the identified features for predicting future network conditions. The model can also include outlier removal for signal strength anomalies, such as normalizing MCS values to a zero to one scale, one-hot encoding categorical variables like congestion states, and so on. The L4S management system 130 can also use time-series decomposition on metrics for the model to identify trends and seasonality in network traffic.

In an embodiment, the training of the model includes splitting the training data into eighty percent training sets and twenty percent validation sets. Cross-validation is used to evaluate the model on different subsets of data, minimizing the validation set's mean squared error. Then, a grid search is applied over a predefined range of hyperparameters for the model, for example focusing on learning rate, number of trees, and tree depth to find the optimal combination that minimizes prediction error. The model can be integrated into the L4S management system 130 for processing real-time network data and updating network condition predictions (e.g., every few milliseconds) to reflect the latest network state.

The model can undergo retraining sessions incorporating the latest data, employing an adaptive learning rate to remain responsive to new congestion patterns without forgetting historical trends. In example implementations, the F1 score is prioritized to balance the precision and recall of congestion predictions, ensuring that the model accurately identifies congestion events without generating excessive false alarms. The model can also implement a feedback loop to evaluate the effectiveness of the L4S management system 130, such as changes to L4S characteristics made based on predicted future network conditions. The model can thus train based on the actual impact of its predictions, continually improving its forecasting accuracy and the effectiveness of preemptive adjustments.

The predictive modeling and adaptation process can be flexible and adaptable to new network technologies and changing network conditions. The L4S management system 130 can for instance incorporate data from next-gen products and emerging technologies to continually refine its predictive capabilities and adaptation strategies.

### Integrated Management

In some embodiments, the cross-layer network data can be used to adjust other operations of the network in addition to adjusting L4S operation. The adjustments can be directed to further improving L4S operation and/or improving other network characteristics. The L4S management system 130 and/or other devices of the network can perform the integrated management operations.

In some embodiments, an integrated cross-layer control algorithm aims to optimize L4S traffic management by synthesizing feedback from multiple network layers (e.g., the PHY, MAC, and network layers) into a unified control strategy. Unlike the direct adjustments to L4S characteristics or adjustments based on predicted network conditions as described above, the integrated cross-layer control algorithm integrates and analyzes data across layers to make informed decisions that affect various aspects of the network simultaneously.

In some embodiments, the L4S management system 130 uses dedicated feedback channels that aggregate real-time metrics from the PHY layer (e.g., such as SNR and MCS), the MAC layer (e.g., frame retry rates and contention statistics), and the network layer (e.g., ECN signals). A standardized data format and communication protocol can be defined for each layer to report its metrics to a central control unit, such as the L4S management system 130. The L4S management system 130 can then utilize a data processing framework capable of analyzing the aggregated cross-layer feedback in real-time. The data processing framework can employ advanced data analytics techniques, including time-series analysis and statistical modeling, to extract actionable insights from the multi-layered data. The L4S management system 130 for example can process the cross-layer data to identify information related to network conditions including patterns and anomalies indicative of emerging congestion or suboptimal network conditions.

The L4S management system 130 can then utilize a decision-making algorithm that dynamically adjusts network parameters based on the data processing. For example, the L4S management system 130 employs a set of predefined rules and heuristics (e.g., derived from network performance objectives) to determine the optimal settings for MAC layer access priorities, PHY layer transmission parameters, and other control levers. The L4S management system 130 can determine the setting for the MAC layer and PHY layer with the goal of optimizing L4S traffic performance and the goal of maintaining overall network efficiency. The L4S management system 130 can implement specific control actions to adjust the MAC layer and PHY layer operation as determined, such as modifying the contention window size in the MAC layer to reduce collisions, adjusting the MCS in the PHY layer for more reliable transmission under current signal conditions, or fine-tuning ECN thresholds to better manage congestion. In example implementations, the L4S management system 130 sends control signals sent to the respective network components to enact the adjustments.

The L4S management system 130 can continuously monitor network conditions and the impact the L4S management system 130 has on network performance through the feedback channels. This real-time monitoring enables the L4S management system 130 to adapt its decisions based on the current network state, ensuring that the optimization objectives are consistently met even as network conditions evolve. Furthermore, the control algorithm can operate in an iterative loop, where each cycle of feedback analysis, decision-making, and control action implementation is followed by a period of monitoring and adaptation. This iterative process allows the L4S management system 130 to learn from its actions and refine its strategies over time, leading to increasingly effective optimization of L4S traffic and network performance.

The effectiveness of the L4S management system 130 and the algorithm's effectiveness can be evaluated against a set of performance benchmarks, including latency, packet loss, and overall network throughput. Based on the evaluation, the L4S management system 130 and/or the algorithm can be adjusted so decision rules and heuristics better align with evolving network conditions and performance goals.

### Method

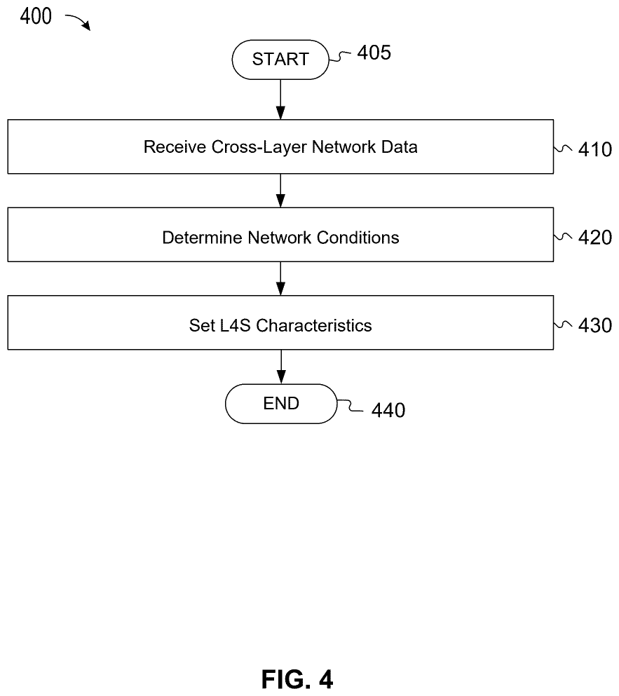

FIG. 4 is a flow chart of a method 400 for L4S traffic management. The method 400 can begin at starting block 405 and proceed to operation 410. In operation 410, network data comprising one or more PHY layer metrics, one or more MAC layer metrics, and one or more network layer metrics is received. For example, the L4S management system 130 receives real-time network data and/or historical network data. In certain embodiments, the one or more PHY layer metrics comprise a SNR and/or a MCS value, the one or more MAC layer metrics comprise a retry rate and/or a contention statistic, and the one or more network layer metrics comprise ECN marking data.

In operation 420, one or more network conditions are determined based on the network data. For example, the L4S management system 130 determines network conditions such as congestion, queuing delay, packet loss rate, L4S marking rate, round-trip time variations, traffic load, link utilization, the mix of flow between L4S and classic traffic, queue occupancy or buffer size, latency, jitter, scheduler backlogs, deviation from fairness targets, network topology or path changes, traffic types, and/or the like.

In operation 430, one or more L4S characteristics are set based on the network conditions. For example, the L4S management system 130 sets L4S characteristics based on the network conditions. In example implementations, setting the one or more L4S characteristics comprises setting a queue size, setting one or more thresholds for ECN marking, setting an ECN marking strategy, setting a drop policy, determining a queue management algorithm, setting a target delay, setting an interval period, setting an update period, setting an L4S balancing strategy, and/or the like.

The method 400 can further comprise setting one or more default L4S characteristics before determining the one or more network conditions. In some embodiment, the method 400 further comprises predicting one or more future network conditions using a predictive machine learning model based on the network data and historical network data, wherein setting the one or more L4S characteristics is further based on the future network conditions. The method 400 comprises adjusting a network parameter based on the one or more network conditions comprising one or more MAC layer access priorities and/or one or more PHY layer transmission parameters in further embodiments. In additional embodiments, the method 400 further comprises determining one or more updated network conditions after setting the one or more L4S characteristics and adjusting the one or more L4S characteristics based on the one or more updated network conditions. The method 400 can conclude at ending block 440.

### Systems

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for managing L4S with respect to FIGS. 1-4. Computing device 500, for example, may provide an operating environment for the STAs 102, the AP 110, the controller 115, the endpoints 125, the L4S management system 130, other network devices 120, and the like. The STAs 102, the AP 110, the controller 115, the endpoints 125, the L4S management system 130, other network devices 120, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

FIG. 6 illustrates an implementation of a communications device 600 that may implement one or more of the STAs 102, the AP 110, the controller 115, the endpoints 125, the L4S management system 130, other network devices 120, etc., of FIGS. 1-4. In various implementations, the communications device 600 may comprise a logic circuit. The logic circuit may include physical circuits to perform operations described for one or more of the STAs 102, the AP 110, the controller 115, the endpoints 125, the L4S management system 130, other network devices 120, etc., of FIGS. 1-4, for example. As shown in FIG. 6, the communications device 600 may include one or more of, but is not limited to, a radio interface 610, baseband circuitry 630, and/or the computing device 500.

The communications device 600 may implement some or all of the structures and/or operations for the STAs 102, the AP 110, the controller 115, the endpoints 125, the L4S management system 130, other network devices 120, etc., of FIGS. 1-4, storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHY processing circuit for the PHY link layer processing of respective receive/transmit signals. Baseband circuitry 630 may include, for example, a MAC processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving network data comprising one or more Physical (PHY) layer metrics, one or more Media Access Control (MAC) layer metrics, and one or more network layer metrics;
determining one or more network conditions based on the network data; and
setting one or more Low Latency, Low Loss, Scalable Throughout (L4S) characteristics based on the one or more network conditions.

2. The method of claim 1, wherein setting the one or more L4S characteristics comprises any one of (i) setting a queue size, (ii) setting one or more thresholds for Explicit Congestion Notification (ECN) marking, (iii) setting an ECN marking strategy, (iv) setting a drop policy, (v) determining a queue management algorithm, (vi) setting a target delay, (vii) setting an interval period, (viii) setting an update period, (ix) setting an L4S balancing strategy, or (x) any combination of (i)-(ix).

3. The method of claim 1, wherein:
the one or more PHY layer metrics comprise a Signal-to-Noise Ratio and a Modulation and Coding Scheme value;
the one or more MAC layer metrics comprise a retry rate and a contention statistic; and
the one or more network layer metrics comprise ECN marking data.

4. The method of claim 1, further comprising setting one or more default L4S characteristics before determining the one or more network conditions.

5. The method of claim 1, further comprising predicting one or more future network conditions using a predictive machine learning model based on the network data and historical network data, wherein setting the one or more L4S characteristics is further based on the future network conditions.

6. The method of claim 1, further comprising adjusting a network parameter based on the one or more network conditions comprising any one of (i) one or more MAC layer access priorities, (ii) one or more PHY layer transmission parameters, or (iii) both (i) and (ii).

7. The method of claim 1, further comprising:
determining one or more updated network conditions after setting the one or more L4S characteristics; and
adjusting the one or more L4S characteristics based on the one or more updated network conditions.

8. A system comprising:
a memory storage; and
a processing unit coupled to the memory storage, wherein the processing unit is operative to:
receive network data comprising one or more Physical (PHY) layer metrics, one or more Media Access Control (MAC) layer metrics, and one or more network layer metrics;
determine one or more network conditions based on the network data; and
set one or more Low Latency, Low Loss, Scalable Throughout (L4S) characteristics based on the one or more network conditions.

9. The system of claim 8, wherein to set the one or more L4S characteristics comprises any one of (i) setting a queue size, (ii) setting one or more thresholds for Explicit Congestion Notification (ECN) marking, (iii) setting an ECN marking strategy, (iv) setting a drop policy, (v) determining a queue management algorithm, (vi) setting a target delay, (vii) setting an interval period, (viii) setting an update period, (ix) setting an L4S balancing strategy, or (x) any combination of (i)-(ix).

10. The system of claim 8, wherein:
the one or more PHY layer metrics comprise a Signal-to-Noise Ratio and a Modulation and Coding Scheme value;
the one or more MAC layer metrics comprise a retry rate and a contention statistic; and
the one or more network layer metrics comprise ECN marking data.

11. The system of claim 8, the processing unit being further operative to set one or more default L4S characteristics before determining the one or more network conditions.

12. The system of claim 8, the processing unit being further operative to predict one or more future network conditions using a predictive machine learning model based on the network data and historical network data, wherein to set the one or more L4S characteristics is further based on the future network conditions.

13. The system of claim 8, the processing unit being further operative to adjust a network parameter based on the one or more network conditions comprising any one of (i) one or more MAC layer access priorities, (ii) one or more PHY layer transmission parameters, or (iii) both (i) and (ii).

14. The system of claim 8, the processing unit being further operative to:
determine one or more updated network conditions after setting the one or more L4S characteristics; and
adjust the one or more L4S characteristics based on the one or more updated network conditions.

15. A non-transitory computer-readable medium that stores a set of instructions which when executed perform a method executed by the set of instructions comprising:
receiving network data comprising one or more Physical (PHY) layer metrics, one or more Media Access Control (MAC) layer metrics, and one or more network layer metrics;
determining one or more network conditions based on the network data; and
setting one or more Low Latency, Low Loss, Scalable Throughout (L4S) characteristics based on the one or more network conditions.

16. The non-transitory computer-readable medium of claim 15, wherein setting the one or more L4S characteristics comprises any one of (i) setting a queue size, (ii) setting one or more thresholds for Explicit Congestion Notification (ECN) marking, (iii) setting an ECN marking strategy, (iv) setting a drop policy, (v) determining a queue management algorithm, (vi) setting a target delay, (vii) setting an interval period, (viii) setting an update period, (ix) setting an L4S balancing strategy, or (x) any combination of (i)-(ix).

17. The non-transitory computer-readable medium of claim 15, wherein:
the one or more PHY layer metrics comprise a Signal-to-Noise Ratio and a Modulation and Coding Scheme value;
the one or more MAC layer metrics comprise a retry rate and a contention statistic; and
the one or more network layer metrics comprise ECN marking data.

18. The non-transitory computer-readable medium of claim 15, the method executed by the set of instructions further comprising setting one or more default L4S characteristics before determining the one or more network conditions.

19. The non-transitory computer-readable medium of claim 15, the method executed by the set of instructions further comprising predicting one or more future network conditions using a predictive machine learning model based on the network data and historical network data, wherein setting the one or more L4S characteristics is further based on the future network conditions.

20. The non-transitory computer-readable medium of claim 15, the method executed by the set of instructions further comprising adjusting a network parameter based on the one or more network conditions comprising any one of (i) one or more MAC layer access priorities, (ii) one or more PHY layer transmission parameters, or (iii) both (i) and (ii).
